(19) United States
(12) Patent Application Publication
(10) Pub. No.: US 2010/0095377 A1
(43) Pub. Date: Apr. 15, 2010

(54) DETECTION OF SUSPICIOUS TRAFFIC PATTERNS IN ELECTRONIC COMMUNICATIONS

(75) Inventor: Andrew Krywaniuk, Vancouver (CA)

Correspondence Address: MICHAEL A DESANCTIS;HAMILTON DESANCTIS & CHA LLP, FINANCIAL PLAZA AT UNION SQUARE, 225 UNION BOULEVARD, SUITE 305, LAKEWOOD, CO, 80228, US

(73) Assignee: FORTINET, INC., Sunnyvale, CA (US)

(21) Appl. No.: 12/637,101

(22) Filed: Dec. 14, 2009

Related U.S. Application Data
(63) Continuation of application No. 12/013,412, filed on Jan. 11, 2008.

(51) Int. Cl. G06F 21/00; G06F 15/16

(52) U.S. Cl. 726/22; 709/206

(57) ABSTRACT

Methods and systems for detecting suspicious traffic patterns in electronic communications are provided. According to one embodiment, an electronic mail (email) message is received by a mail filter (milter), which evaluates a traffic pattern represented by the email message by scanning information associated with the email message and comparing it to information associated with one or more traffic analysis profiles. If the email message is identified by the milter as being inconsistent with normal email traffic patterns as represented by the one or more traffic analysis profiles, then the milter causes the email message to be handled in accordance with an email security policy associated with suspicious traffic patterns. For example, in the context of an outbound message, the originator may be alerted to a factor contributing to the identification and the originator may be provided with an opportunity to address the factor.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright ©2007-2009, Fortinet, Inc.

### BACKGROUND

1. Field

Embodiments of the present invention generally relate to information leak management and electronic communications. In particular, embodiments of the present invention relate to scanning of electronic mail (email) messages to identify suspicious traffic patterns.

2. Description of the Related Art

Electronic mail (email) is an indispensable commodity in today's world. Confidential and/or sensitive business, medical, or personal data is routinely exchanged over the Internet, and companies have a need (sometimes even a legal obligation) to protect this information. Information Leak Management (ILM) is the practice of protecting sensitive information from being accidentally (or even deliberately) copied beyond its intended scope.

Cybersquatting is the practice of registering a domain name that could be associated with a product or service that the registrant does not own/offer, usually with the intention of reselling that domain name for a profit. In the meantime, cybersquatters may put something else on the site, such as a webpage just for advertising. Sometimes cybersquatters may even attempt to sell a competitor's product via the website. In some cases, the website may be used to attempt to install malware on visitors' PCs.

In some cases, the cybersquatter registers a misspelling or variant of a company name. Cybersquatters' intentions can be unpredictable. For example, consider a corporate website, such as www.starbucks.com. As of June 2007, http://www.starbcks.com/ redirects to a portal page with ads for competing brands of coffee, whereas http://www.starbuks.com/ redirects to http://www.iphones.com/, and http://www.starbucks.net/ just redirects to a placeholder ad for VeriSign.

In the case of email, users often type in the destination addresses by hand. Thus, there is always the possibility of a user making a mistake. If the user specifies an email address that does not exist, typically this should result in the email “bouncing.” Thus, it would be delivered to nobody and a notification would be returned to the sender. However, an unscrupulous cybersquatter could very well have set up a mail server at the variant domain and configured it to accept emails to any address at that domain. In this way, the cybersquatter can capture legitimate emails destined to real users at the corporate network.

Furthermore, the misspelled or variant (e.g., *.net instead of *.com) domain name may be similar enough to the actual domain name that users may not be able to notice the difference. The same scammer that captures emails sent to the variant domain name can also send out messages originating from that domain. These messages will not trigger many of the most basic spam detection rules (e.g., checking whether the domain name exists). If the scammer can convince the recipient that he is actually the user at the legitimate domain, then he/she may entice them into revealing additional sensitive or confidential information.

Thus, there is a need in the art for a system and method of detecting suspicious electronic communications, such as those containing or originating from misspelled and/or deliberately misleading email addresses.

### SUMMARY

Methods and systems are described for detecting suspicious traffic patterns in electronic communications. According to one embodiment, an electronic mail (email) message is received by a mail filter (milter). The milter evaluates a traffic pattern represented by the email message by scanning information associated with all or a portion of the email message and comparing all or a portion of the scanned information to information associated with one or more traffic analysis profiles. If the email message is identified by the milter as being inconsistent with normal email traffic patterns as represented by the one or more traffic analysis profiles, then the milter causes the email message to be handled in accordance with an email security policy associated with suspicious traffic patterns.

In the aforementioned embodiment, at least one of the traffic analysis profiles may be a Bayesian database and the method further involves training the Bayesian database based on normal email traffic patterns.

In various instances of the aforementioned embodiments spam email messages and email messages containing viruses may be excluded from the training of the Bayesian database.

In the context of various of the aforementioned embodiments, the traffic analysis profiles may be part of a multi-tier Bayesian filter.

In various instances of the aforementioned embodiments, the multi-tier Bayesian filter may include an enterprise-level database, a per-server database and a per-user database and the method may further involve email traffic between email addresses/domains being monitored at multiple levels of specificity. Furthermore, in connection with making a determination regarding normalcy of a given email traffic pattern, results associated with a more specific database of the multi-tier Bayesian filter may overrule results of a less specific database of the multi-tier Bayesian filter.

In the context of various of the aforementioned embodiments, the method may include causing one or more Bayesian filters to be applied to the email message or a portion thereof.

In various instances of the aforementioned embodiments, the Bayesian filters may include a global database based on traffic analysis of observed email traffic, a per-server database based on traffic analysis of observed email traffic for a particular email server and/or a per-user database based on traffic analysis of observed email for a particular user email account.

In various instances of the aforementioned embodiments, the method may further involve the email message being identified as inconsistent with normal email traffic patterns based upon a source email address or a destination email addresses being inconsistent with normal email traffic patterns reflected by the one or more traffic analysis profiles.

In the context of various of the above-referenced embodiments, the method may further involve concurrent performance of anti-spam processing, anti-phishing processing, anti-virus processing and/or other email security functions by the milter.

In the context of various of the above-referenced embodiments, the email message may represent an outbound email message originated by an end user and causing the email message to be handled in accordance with an email security policy associated with suspicious traffic patterns may involve alerting the end user to one or more factors contributing to the identification of the email message as being inconsistent with normal email traffic patterns by causing the outbound email message to be displayed with the one or more factors highlighted. Additionally, the end user may be provided with an opportunity to address the one or more factors.

Other embodiments of the present invention provide a program storage device readable by an electronic mail (email) processing computer system, tangibly embodying a program of instructions executable by the email processing computer system to perform method steps for evaluating email messages. An electronic mail (email) message is received. A traffic pattern represented by the email message is evaluated by scanning information associated with all or a portion of the email message and comparing all or a portion of the scanned information to information associated with one or more traffic analysis profiles. If the email message is identified as being inconsistent with normal email traffic patterns as represented by the one or more traffic analysis profiles, then the email message is subsequently handled in accordance with an email security policy associated with suspicious traffic patterns.

In the aforementioned embodiment, the method may further involve causing one or more Bayesian filters to be applied to the email message or a portion thereof.

In various instances of the aforementioned embodiments, the Bayesian filters may include a global database based on traffic analysis of observed email traffic, a per-server database based on traffic analysis of observed email traffic for a particular email server and/or a per-user database based on traffic analysis of observed email for a particular user email account.

In the context of various of the aforementioned embodiments, the email processing computer system may be part of or include an email firewall, an email security platform, a network security appliance or a gateway.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram conceptually illustrating a simplified network architecture in which embodiments of the present invention may be employed.

FIG. 2 is a block diagram conceptually illustrating interaction among various functional units of an email firewall with a client and server in accordance with one embodiment of the present invention.

FIG. 3 is a block diagram conceptually illustrating interaction among various functional units of an email firewall with a client and server in accordance with another embodiment of the present invention.

FIG. 4 is a block diagram conceptually illustrating interaction among various functional units of an email firewall with a client and server in accordance with yet another embodiment of the present invention.

FIG. 5 is a block diagram conceptually illustrating interaction among various functional units of an email firewall with a client and server in accordance with yet another embodiment of the present invention.

FIG. 6 is a block diagram conceptually illustrating interaction among various functional units of an email firewall with a client, a server and a uniform resource locator (URL) rating service in accordance with one embodiment of the present invention.

FIG. 7 is an example of a computer system with which embodiments of the present invention may be utilized.

FIG. 8 is a flow diagram illustrating email address inspection processing in accordance with an embodiment of the present invention.

FIG. 9 is a flow diagram illustrating email address inspection processing in accordance with another embodiment of the present invention.

FIG. 10 is a flow diagram illustrating email address inspection processing in accordance with yet another embodiment of the present invention.

FIG. 11 is a flow diagram illustrating email address inspection processing in accordance with yet another embodiment of the present invention.

FIG. 12 is a flow diagram illustrating email address inspection processing in accordance with yet another embodiment of the present invention.

### DETAILED DESCRIPTION

Methods and systems are described for detecting suspicious trafficpatterns in electronic communications. According to one embodiment, a mail filter (milter) scans inbound and outbound email messages to generate a profile (e.g., a Bayesian filter) which measures the confidence that addresses in an email message are correct and/or legitimate. The milter may then be tuned by applying one or more of semantic/dictionary analysis (looking for probable misspellings or deliberately misleading variations of know domains) and comparisons against one or more uniform resource locator (URL) rating services (e.g., the FORTIGUARD web filtering service available from Fortinet, Inc. of Sunnyvale, Calif.). Then, for each inbound and/or outbound email message, email addresses contained therein can be validated using the milter. If a probable misspelling or probable deliberately misleading destination address is detected in an outbound email message, the message can be dropped or bounced. If a probable misspelling or probable deliberately misleading source address is detected in an inbound message, the message can be quarantined or the recipient can be alerted. In one embodiment, the thresholds for detection can be adjusted based on the estimated sensitivity of the email message content.

Importantly, although various embodiments of the present invention are discussed in the context of an email firewall, they are also applicable to other virtual or physical network devices or appliances that may be logically interposed between clients and servers or otherwise positioned to observe electronic communication traffic, such as firewalls, network security appliances, network gateways, virtual private network (VPN) gateways, switches, bridges, routers and the like. Similarly, the functionality described herein may be fully or partially implemented within a server, such as an email server, or within a client workstation or client-side application, such as an email client.

While for sake of illustration embodiments of the present invention are described with respect to heuristics being applied to email messages, it is to be understood that embodiments of the present invention have broader applicability to electronic communications more generally. For example, various aspects and features of embodiments of the present invention may be used in connection with other forms of electronic communications, including, but not limited to, text messaging (e.g., Short

Message Service (SMS)), Multimedia Message Service (MMS), instant messaging/chat (e.g., Internet Relay Chat (IRC)) and/or the like.

For purposes of simplicity, various embodiments of the present invention are described with reference to a milter, which is configured to detect misspelled and/or deliberately misleading email addresses. It is to be noted, however, that the milter may also perform other functions, such as spam and virus protection. In some cases, detection of illegitimate email addresses may be performed concurrently, in series or in conjunction with anti-virus, anti-spam, anti-phishing and/or other content processing/scanning/filtering functionality. In some cases, the heuristic results of one scanning engine may be used as inputs to another scanning engine. Additionally, according to various embodiments described below, a milter process running on a particular device is invoked to perform email address inspection services by a process, such as a mail server, mail firewall or email client, running on the same device; however, the present invention is not so limited and the milter may run on the same or different device as the entity requesting the service.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

### Terminology

Brief definitions of terms used throughout this application are given below.

The terms “connected” or “coupled” and related terms are used in an operational sense and are not necessarily limited to a direct connection or coupling.

The term “client” generally refers to an application, program, process or device in a client/server relationship that requests information or services from another program, process or device (a server) on a network. Importantly, the terms “client” and “server” are relative since an application may be a client to one application but a server to another. The term “client” also encompasses software that makes the connection between a requesting application, program, process or device to a server possible, such as an email client.

The phrase “electronic communication” generally refers to any form of asynchronous digital communication, which contains an indication of a source address and/or one or more destination addresses. Thus, electronic communications include, but are not limited to electronic mail (email) messages; text messaging (e.g., Short Message Service (SMS)), Multimedia Message Service (MMS), instant messaging/chat (e.g., Internet Relay Chat (IRC)) and/or the like. Based on the disclosure provided herein, one of ordinary skill in the art will appreciate a variety of other current and future forms of asynchronous digital communication consistent with the aforementioned definition.

The phrase “email firewall” generally refers to functionality which inspects electronic communications passing through it, and denies or permits passage based on a set of rules. An email firewall can be implemented completely in software, completely in hardware, or as a combination of the two. In one embodiment, an email firewall is a dedicated appliance. In other embodiments, an email firewall may be software running on another computer, such as an email server, client workstation, network gateway, router or the like.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

The phrases “mail filter,” “email filter,” “milter” and the like generally refer to processing, such as spam or virus filtering and/or message blocking, verification and/or sorting, that may be inserted into an electronic communication processing chain. In one embodiment, a milter is operable within an email firewall to identify suspicious email messages, such as those containing likely misspelled and/or deliberately misleading email addresses. Milters may also be implemented as extensions to mail transfer agents (MTA) or operable within other network devices through which electronic communications flow. Generally, milters are designed to efficiently perform specific functionality while preserving reliable electronic communication delivery without taking over other responsibilities, such as generating bounce messages and the like.

The phrase “network gateway” generally refers to an internetworking system, a system that joins two networks together. A “network gateway” can be implemented completely in software, completely in hardware, or as a combination of the two. Depending on the particular implementation, network gateways can operate at any level of the OSI model from application protocols to low-level signaling.

If the specification states a component or feature “may”, “can”, “could”, or “might” be included or have a characteristic, that particular component or feature is not required to be included or have the characteristic.

The term “responsive” includes completely or partially responsive.

The term “server” generally refers to an application, program, process or device in a client/server relationship that responds to requests for information or services by another program, process or device (a server) on a network. The term “server” also encompasses software that makes the act of serving information or providing services possible. The term “server” also encompasses software that makes the act of serving information or providing services possible.

The phrase “suspicious address” generally refers to a source or destination address of an electronic communication that is considered suspicious for one or more reasons. In one embodiment, reasons for suspicion of an address include, but are not limited to, the address being determined to be misspelled and/or deliberately misleading, a friendly name being associated with an email address different than that expected, existence of the address or a portion thereof (e.g., a domain) within a known list of misspellings, a variation in normal traffic or communication patterns, a heuristic determination of suspiciousness, similarity of the address to a list of target addresses and/or domains and an associated domain having a low legitimacy score or an unacceptable usage policy as reported by a URL rating database, such as the FORTIGUARD web filtering service.

### Overview

One or more embodiments of the present invention may include combinations of various of the following features:
1. A milter provided with a static list of possible misspellings of one or more target domain names.
2. A milter provided with a dynamic list of possible misspellings of one or more target domain names where the milter populates the list by traffic analysis. For example, the milter may monitor email traffic to generate a list of observed email addresses and/or domain names. Then, the milter may scan the list to detect if any of the names are probable misspellings of other names on the list.
3. The list of possible misspellings of one or more target domain names may be generated by calculating probable misspellings based on human typing patterns.
4. In some instances, there may be no list of possible misspellings at all, and the milter may simply calculate the probability of a misspelling at run time via heuristic rules.
5. In some cases, the results of the email address scanning may be cross-referenced with a URL rating database. The URL ratings may be used to judge the degree of legitimacy associated with a domain name. If a domain name with a low legitimacy score or an unacceptable usage policy is deemed to be similar to another domain name with a high legitimacy score and/or acceptable usage policy then an e-mail to/from that domain may be considered suspicious.
6. In some cases, the filtering may be targeted at individual users by building traffic analysis profiles of their intercommunications. For example, normal email traffic patterns may be used to train a Bayesian database of intercommunications between email addresses/domains. If an email message's to and/or from addresses match the normal pattern of communication, then no further action may be taken. On the other hand, if the system detects an email between two users who have not previously communicated, then further heuristic analysis may be launched.
7. Multiple tiers of Bayesian filters (e.g., a global database, a per-server database, and/or a per-user database) may be employed. Results of the more specific database may be used to overrule the result of a more generic database if results of the more generic database are inconclusive.
8. White and/or black lists may be used to override any or all of the heuristically generated rules.

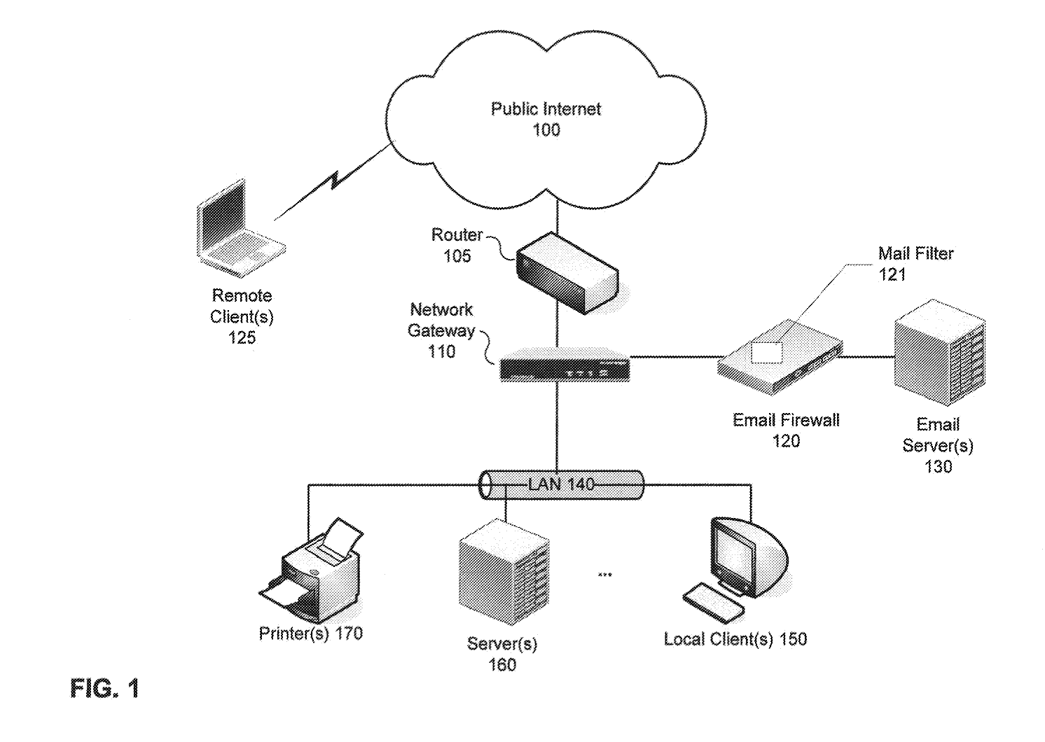

FIG. 1 is a block diagram conceptually illustrating a simplified network architecture in which embodiments of the present invention may be employed. In this simple example, one or more remote clients 125 and local clients 150 are coupled in communication with an email firewall 120, which incorporates various novel email address inspection/scanning methodologies within a mail filter 121 that are described further below. In the present example, email firewall 120 is logically interposed between remote clients 125 and local clients 150 and the public Internet 100 to allow all email messages (e.g., inbound and/or outbound) exchanged among clients and among clients and external entities (e.g., those not associated with local area network (LAN) 140) to be scanned.

According to one embodiment, mail filter 121 is invoked by a mail delivery process associated with local clients 150, email servers 130, email firewall 120 or network gateway 110, thereby effectively intercepting electronic communications between or among the clients (e.g., remote clients 125 and local clients 150) and external entities outside of LAN 140. When invoked, mail filter 121 may perform scanning of electronic communications to detect suspicious electronic communications, such as electronic mail (email) messages containing, originated or purportedly originated from misspelled and/or deliberately misleading addresses. As indicated above, in addition to scanning email addresses and/or domains, the milter may also perform other functions such as anti-virus, anti-spam, anti-phishing and/or other content processing/scanning/filtering functionality.

According to the present example, email firewall 120 is coupled in communication with one or more email servers 130 from which and through which remote clients 125 and client workstations 150 residing on LAN 140 may retrieve and send email correspondence. LAN 140 is communicatively coupled with the public Internet 100 via a network gateway 110 and a router 105. Email firewall 120 may perform email filtering in addition to that performed by milter 121. For example, email firewall 120 may detect, tag, block and/or remove unwanted spam and malicious attachments. In one embodiment, email firewall 120 performs one or more spam filtering techniques, including but not limited to, sender IP reputation analysis and content analysis, such as attachment/content filtering, heuristic rules, deep email header inspection, spam URI real-time blocklists (SURBL), banned word filtering, spam checksum blocklist, forged IP checking, greylist checking, Bayesian classification, Bayesian statistical filters, signature reputation, and/or filtering methods such as FORTIGUARD-Antispam, access policy filtering, global and user black/white list filtering, spam Real-time Blackhole List (RBL), Domain Name Service (DNS) Block List (DNSBL) and per user Bayesian filtering so individual users can establish and/or configure their own profiles. Existing email security platforms that exemplify various operational characteristics of email firewall 120 according to an embodiment of the present invention include the FORTIMAIL family of high-performance, multi-layered email security platforms, including the FORTIMAIL-100 platform, the FORTIMAIL-400 platform, the FORTIMAIL-2000 platform and the FORTIMAIL-4000A platform all of which are available from Fortinet, Inc. of Sunnyvale, Calif.

In one embodiment, network gateway 110 acts as an interface between the LAN 140 and the public Internet 100. The network gateway 110 may, for example, translate between dissimilar protocols used internally and externally to the LAN 140. Depending upon the distribution of functionality, the network gateway 110, router 105 or a firewall (not shown) may perform network address translation (NAT) to hide private Internet Protocol (IP) addresses used within LAN 140 and enable multiple client workstations, such as client workstations 150, to access the public Internet 100 using a single public IP address. Also residing on LAN 140 are one or more servers 160 and printers 170. Various other devices, such as storage devices and the like may also be connected to LAN 140.

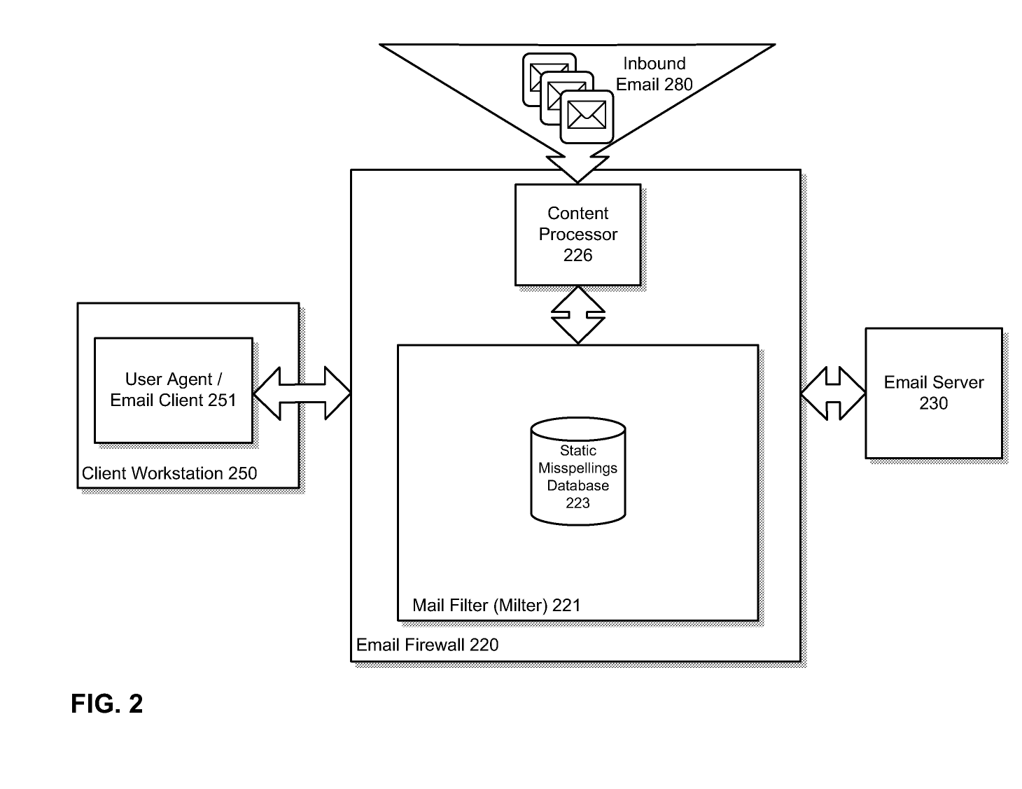

FIG. 2 is a block diagram conceptually illustrating interaction among various functional units of an email firewall 220 with a client workstation 250 and an email server 230 in accordance with one embodiment of the present invention. While in this simplified example, only a single client workstation, i.e., client workstation 250, and a single email server, i.e., email server 230, are shown interacting with an email firewall 220, it should be understood that many local and/or remote client workstations, servers and email servers may interact directly or indirectly with the email firewall 220 and directly or indirectly with each other.

According to the present example, the email firewall 220, which may be a virtual or physical device, includes two high-level interacting functional units, a mail filter (milter) 221 and a content processor 226. In one embodiment, milter 221 subjects both inbound email 280 and outbound email messages (not shown) to email address/domain scanning responsive to content processor 226. Content processor 226 may initiate scanning of email messages transferred between user agent/email client 251 and email server 230 by invoking milter 221 and potentially performs other traditional anti-virus detection and content filtering on the e-mail messages. In some cases, email address scanning milter results may be expressed as a numerical score, which may then be used in concert with the results of anti-virus, anti-spam, anti-phishing or other content filtering processing of content processor 226; or the email address scanning milter result may be used in connection with other milter functions. Additionally or alternatively, results of content processor 226 evaluation of an email message may be used as an input by milter 221 in connection with its email address scanning processing. Depending upon the implementation, email address scanning by milter 221 may be performed on either or both of incoming email messages and outgoing email messages. Furthermore, the action taken upon detecting a suspicious email message may be different for inbound vs. outbound email messages.

In the present example, milter 221 is configured with a static misspellings database 223 containing a static list of possible misspellings of one or more target domain names. In one embodiment, email address scanning performed by milter 221 may be enabled for all domains. In other cases, the scanning may be enabled only for a selected list of domains. For example, a company may enable detection just for its own domain name and for the names of its major partners, customers, and suppliers. In this case, the scanning process can be optimized, since it is tailored to a small list of names.

In some cases, a company may wish to prevent e-mails from being sent to a legitimate user's non-work address, especially in the case where the legitimacy of such address cannot be easily verified. For example, if a company employs Fred Smith (fredsmith@companya.com), then they may be suspicious of any email messages directed to fredsmith@yahoo.com, since there is no way to verify that it is the same Fred Smith. Additionally, many email messages contain a “friendly name” in the header in addition to the email address. In some embodiments, email address scanning may also be based on this friendly name in addition to the email address, since many email clients will only display the friendly name to the user by default rather than the full email address.

In one embodiment, the functionality of one or more of the above-referenced functional units may be merged in various combinations. For example, milter 221 may be incorporated within content processor 226, email server 230 or client workstation. In some embodiments, miler 221 may be integrated within a router or network gateway. Moreover, the functional units can be communicatively coupled using any suitable communication method (e.g., message passing, parameter passing, and/or signals through one or more communication paths etc.). Additionally, the functional units can be physically connected according to any suitable interconnection architecture (e.g., fully connected, hypercube, etc.).

According to embodiments of the invention, the functional units can be any suitable type of logic (e.g., digital logic) for executing the operations described herein. Any of the functional units used in conjunction with embodiments of the invention can include machine-readable media including instructions for performing operations described herein. Machine-readable media include any mechanism that provides (i.e., stores and/or transmits) information in a form readable by a machine (e.g., a computer). For example, a machine-readable medium includes read only memory (ROM), random access memory (RAM), magnetic disk storage media, optical storage media, flash memory devices, electrical, optical, acoustical or other forms of propagated signals (e.g., carrier waves, infrared signals, digital signals, etc.), etc.

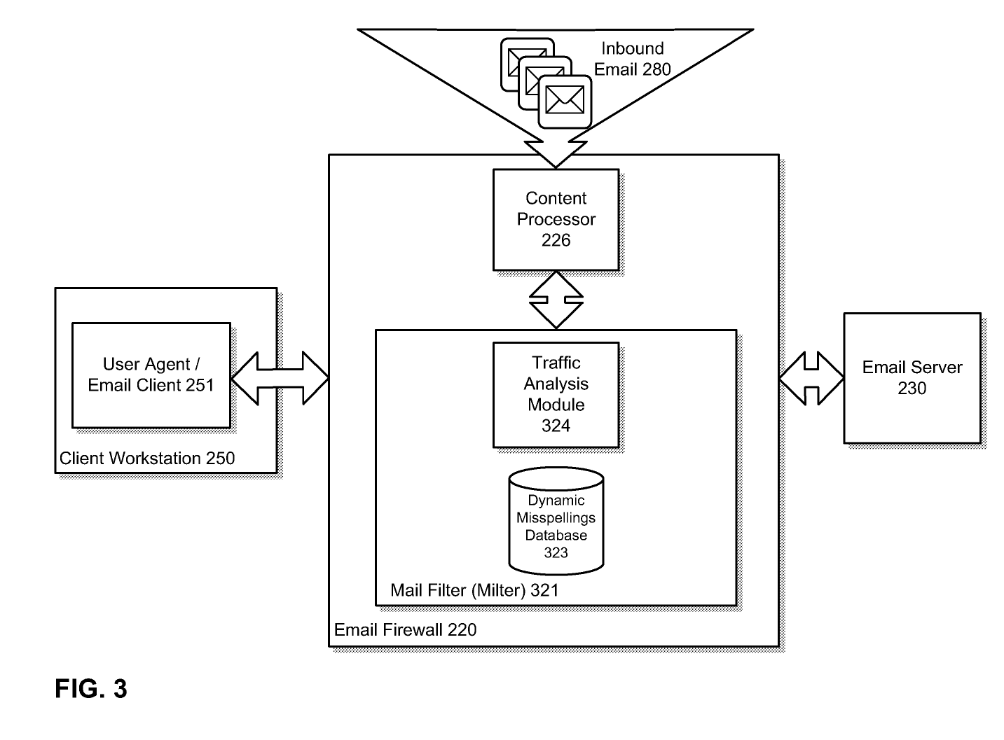

FIG. 3 is a block diagram conceptually illustrating interaction among various functional units of an email firewall 220 with a client workstation 250 and an email server 230 in accordance with another embodiment of the present invention.

According to the present example, email firewall 220 includes a milter 312, which performs analysis of electronic communication traffic. In one embodiment, traffic analysis module 324 monitors email traffic to generate a list of observed email addresses and/or domain names. These observed email addresses and/or domain names as well as probable misspellings thereof may be stored in a dynamic misspellings database 323. Potential misspellings may be identified within the observed list by various means, such as nearest neighbor algorithms, frequency of observation, by calculating probable misspellings based on human typing patterns, or other current or future algorithms employed by spell checkers or online dictionaries. Potential misspelling candidates would typically include, for example, email addresses/domains omitting one or more letters, having inserted letters, containing swapped letter positions within a word, including mistyped letters that are similar (e.g., ‘c’ for ‘s’) or letters next to each other on the keyboard (e.g., ‘f’ and ‘g’ on a QWERTY keyboard).

In some cases, milter 321 may be configured to filter all email messages destined for a known user (e.g., same email address or same friendly name) at a domain other than an expected one based on the traffic analysis. In one embodiment, this restriction could be relaxed such that “Fred Smith” at domain A is allowed to send a message to “Fred Smith” at an unknown domain, but any other user at site A cannot. The implication being that Fred Smith knows which of his own email addresses are legitimate, whereas others might not. Milter 312 could even detect this and add the unknown “Fred Smith” address to a white list.

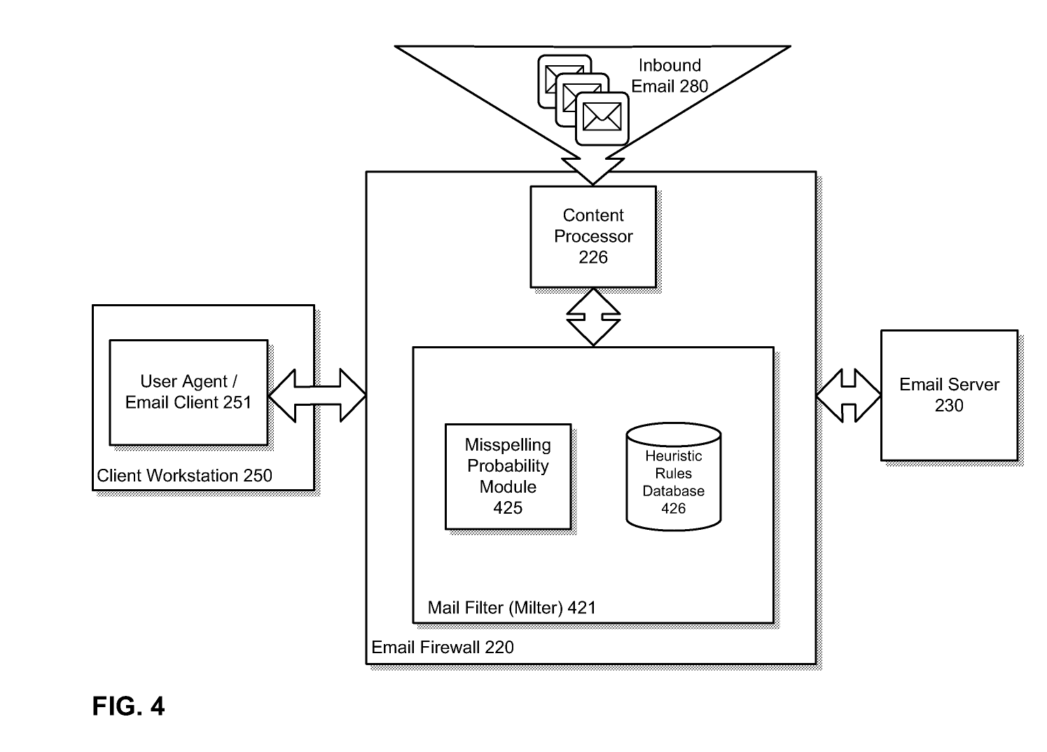

FIG. 4 is a block diagram conceptually illustrating interaction among various functional units of an email firewall 220 with a client workstation 250 and an email server 230 in accordance with yet another embodiment of the present invention.

According to the present example, email firewall 220 includes a milter 312, which calculates the probability of a misspelling at run time without traffic analysis (e.g., without reference to a list of observed email addresses). In one embodiment, milter 421 includes a misspelling probability module 425 and a heuristic rules database 426. Misspelling probability module 425 calculates the probability of a misspelling at run-time based on the heuristic rules of heuristic rules database 426. For example, misspelled email addresses and/or domain names may be identified based on unusual letter patters. However, more typically, to perform heuristic detection without prior traffic analysis, the milter 312 would preferably be configured with a list of “interesting” domain names and the misspelling probability module 425 would then search for probable misspellings of these names. For example, the interesting domain names might include those of the corporate entity itself, business partners, customers, and suppliers.

In cases in which a list of known misspellings is generated without traffic analysis, many of the algorithms discussed herein may still be used; however, a signature for detecting the probable misspelling may alternatively be used and be expressed as a regular expression rather than being expanded into a long list of words. In other instances, the signature may be expressed in some other type of content matching language.

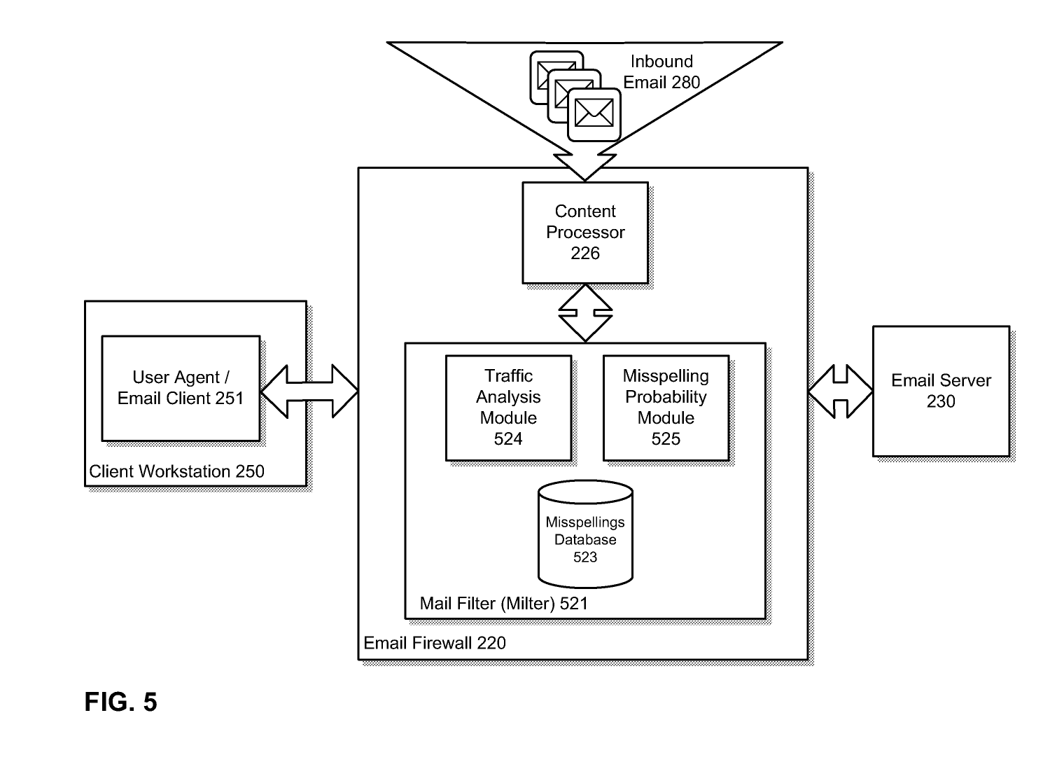

FIG. 5 is a block diagram conceptually illustrating interaction among various functional units of an email firewall with a client and server in accordance with yet another embodiment of the present invention.

According to the present example, email firewall 220 includes a milter 512, which is configured to perform both misspelling probability calculation as well as analysis of electronic communication traffic. In one embodiment, milter 521 includes a traffic analysis module 524, a misspelling probability module 525 and a misspellings database 523. In one embodiment, traffic analysis module 524 monitors email traffic and/or other network traffic to generate a list of observed email addresses and/or domain names. These observed email addresses and/or domain names as well as probable misspellings thereof may be stored in a dynamic misspellings database 523.

Misspelling probability module 525 may calculate the probability of misspellings at run time as described above. In one embodiment, until sufficient observations have been made by the traffic analysis module 524, scanning results of misspelling probability module 525 may be relied upon heavily if not exclusively. The relative weightings of scanning results based on traffic analysis and the scanning results based on misspelling probability calculation may be adjusted overtime. For example, as more observations are made by the traffic analysis module 524, email address scanning may rely less upon the misspelling probability module 525

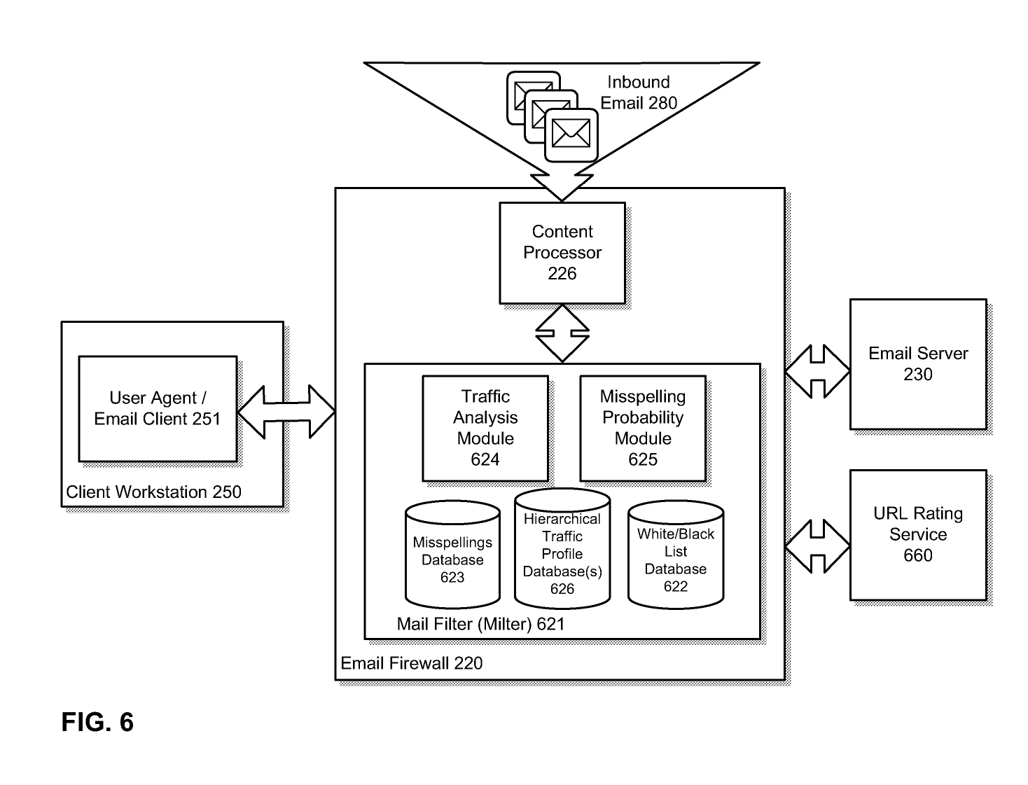

FIG. 6 is a block diagram conceptually illustrating interaction among various functional units of an email firewall 220 with a client workstation 250, an email server 230 and a URL rating service 660 in accordance with one embodiment of the present invention.

According to the present example, email firewall 220 interacts with client workstation 250, email server 230 and a uniform resource locator (URL) rating service 660. URL rating service 660 may be used by email firewall 220 to judge the degree of legitimacy associated with a domain name. If a domain name with a low legitimacy score or an unacceptable usage policy is deemed to be similar to another domain name with a high legitimacy score and/or acceptable usage policy then electronic communications to/from that domain may be considered suspicious. An example of a URL rating service that may be used is the FORTIGUARD web filtering service a subscription service available from Fortinet, Inc of Sunnyvale, Calif. In some embodiments, multiple tiers of URL rating services may be employed, such as a global server in addition to a list of local overrides.

In the present example, email firewall 220 includes a milter 621, which is configured to perform both misspelling probability calculation as well as analysis of electronic communication traffic. In one embodiment, milter 621 includes a traffic analysis module 624, a misspelling probability module 625, traffic profile database(s) 626, a misspellings database 623 and one or more white/black list databases 622. Misspelling probability module 625 may be configured as described above with respect to misspelling probability module 525 of FIG. 5.

As above, traffic analysis module 624 may monitor email traffic to generate a list of observed email addresses and/or domain names. These observed email addresses and/or domain names may be used to generate a list of probable misspellings that may be stored in a dynamic misspellings database, such as misspellings database 623. Additionally, traffic analysis module 624 may be configured to build traffic analysis profiles relating to various levels of intercommunications. For example, normal email traffic may be used to train one or more Bayesian databases (e.g., traffic profile database(s) 626) regarding intercommunications between email addresses/domains at a global level, at a per-server level and/or at a per-user level, thereby allowing abnormal and/or new communication patterns to be detected. In one embodiment, traffic profile database(s) 626 comprises multiple tiers of Bayesian filters (e.g. a global database, a per-server database, and a per-user database), and the result of the more specific database could overrule the result of the more generic database if its results are conclusive.

White/black list database 622 may contain email addresses or domains for which the degree of suspiciousness is hard coded. For example, an email address associated with a white list may be marked or flagged as being not suspicious despite having been found in the misspelling database, an email address associated with a black list may be marked or flagged as being suspicious despite having not been found in the misspelling database and any of the heuristically generated rules may be overridden. For instance, as described above, an enterprise (e.g., Company A) may wish to filter email messages sent to a known user (e.g., Fred Smith) at a domain other than the expected one (e.g., companya.com), but once the milter learns of one or more legitimate personal email addresses associated with Fred Smith, then these may be added to a white list.

As indicated above, in any of the example architectures described therein, the functionality of one or more of the functional units may be merged or distributed in various alternative combinations. Additionally, the functional units can be any suitable type of logic (e.g., digital logic, software, firmware and/or a combination thereof) for executing the operations described herein.

In any of the examples described above, when the milter detects that an email address is suspicious, it may take any of a variety of actions, including but not limited to, logging an event, dropping the email message at issue, quarantining the email message at issue, tagging the email message at issue as spam, tagging the email message at issue as possible phishing, alerting the email user of the existence of a suspicious email address (e.g., displaying the email address at issue in a different font or color scheme), requesting the sender to reconfirm that the email address at issue is correct (e.g., by popping up a confirmation dialog or asking them to reply to a confirmation email message). The action taken may be different for inbound vs. outbound email messages.

As described further below, in some cases, the determination that an email message or email address is suspicious may be made simply by examining the email address at issue; however, in other cases, email address heuristics may be expressed as a numerical score, which may then be used in concert with the results of anti-spam processing, anti-phishing processing, anti-virus processing and/or other email security functions performed by the milter and/or the content processor. Any of the static or heuristically seeded lists described herein could be published to a web site or transmitted to a central server and then shared with other sites, possibly via a subscription service.

It should be noted that the above-described architectures are merely exemplary, and that one of ordinary skill in the art will recognize a variety of alternative and/or additional combinations/permutations of the various functional units that may be utilized in relation to different embodiments of the present invention. For example, although a white/black list database is only described with reference to the embodiment of FIG. 6, one of ordinary skill in the art will recognize that a white/black list database may be used in any or all cases to override misspelling determinations, heuristic rule violations and/or suspiciousness determination.

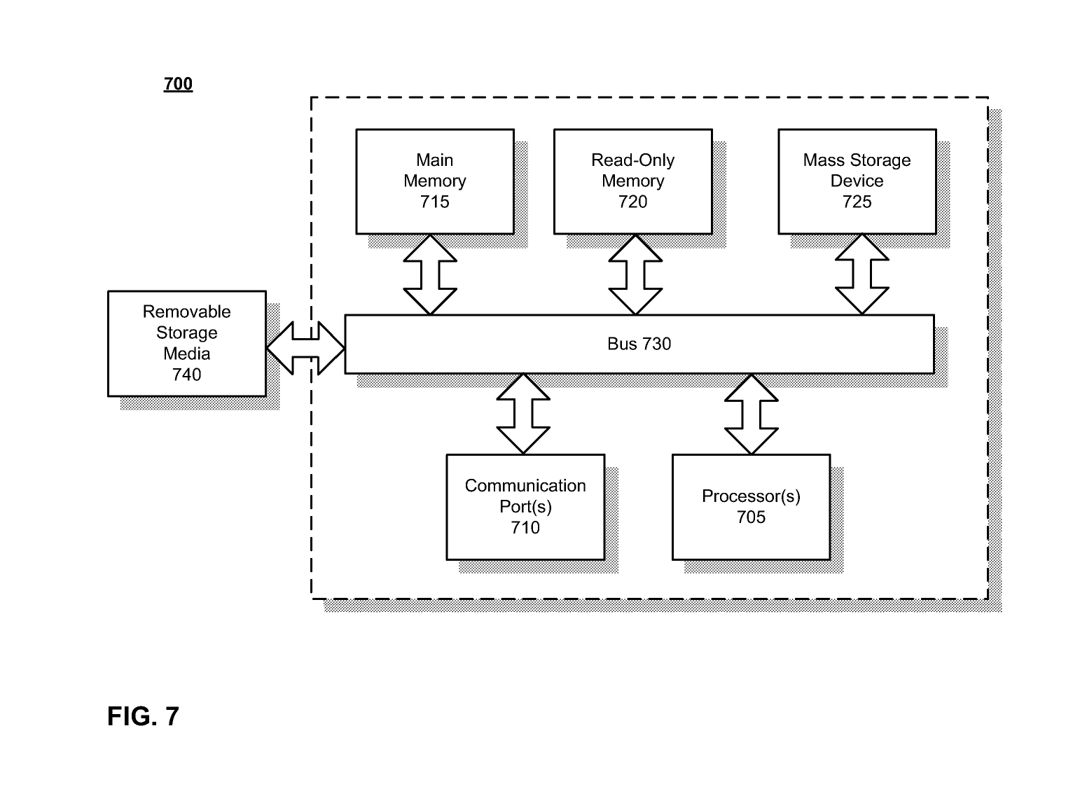

FIG. 7 is an example of a computer system with which embodiments of the present invention may be utilized. The computer system 700 may represent or form a part of an email firewall, network gateway, firewall, network appliance, switch, bridge, router, data storage devices, server, client workstation and/or other network device implementing one or more of the milter 221, 321, 421, 521 or 621 or other functional units depicted in FIGS. 3-6. According to FIG. 7, the computer system 700 includes one or more processors 705, one or more communication ports 710, main memory 715, read only memory 720, mass storage 725, a bus 730, and removable storage media 740.

The processor(s) 705 may be Intel® Itanium® or Itanium 2® processor(s), AMD® Opteron® or Athlon MP® processor(s) or other processors known in the art. Communication port(s) 710 represent physical and/or logical ports. For example communication port(s) may be any of an RS-232 port for use with a modem based dialup connection, a 10/100 Ethernet port, or a Gigabit port using copper or fiber. Communication port(s) 710 may be chosen depending on a network such a Local Area Network (LAN), Wide Area Network (WAN), or any network to which the computer system 700 connects.

Communication port(s) 710 may also be the name of the end of a logical connection (e.g., a Transmission Control Protocol (TCP) port or a Universal Datagram Protocol (UDP) port). For example communication ports may be one of the Well Know Ports, such as TCP port 25 (used for Simple Mail Transfer Protocol (SMTP)) and TCP port 80 (used for HTTP service), assigned by the Internet Assigned Numbers Authority (IANA) for specific uses.

Main memory 715 may be Random Access Memory (RAM), or any other dynamic storage device(s) commonly known in the art.

Read only memory 720 may be any static storage device(s) such as Programmable Read Only Memory (PROM) chips for storing static information such as instructions for processors 705.

Mass storage 725 may be used to store information and instructions. For example, hard disks such as the Adaptec® family of SCSI drives, an optical disc, an array of disks such as RAID, such as the Adaptec family of RAID drives, or any other mass storage devices may be used.

Bus 730 communicatively couples processor(s) 705 with the other memory, storage and communication blocks. Bus 730 may be a PCI/PCI-X or SCSI based system bus depending on the storage devices used.

Optional removable storage media 740 may be any kind of external hard-drives, floppy drives, IOMEGA® Zip Drives, Compact Disc-Read Only Memory (CD-ROM), Compact Disc-Re-Writable (CD-RW), Digital Video Disk (DVD)-Read Only Memory (DVD-ROM), Re-Writable DVD and the like.

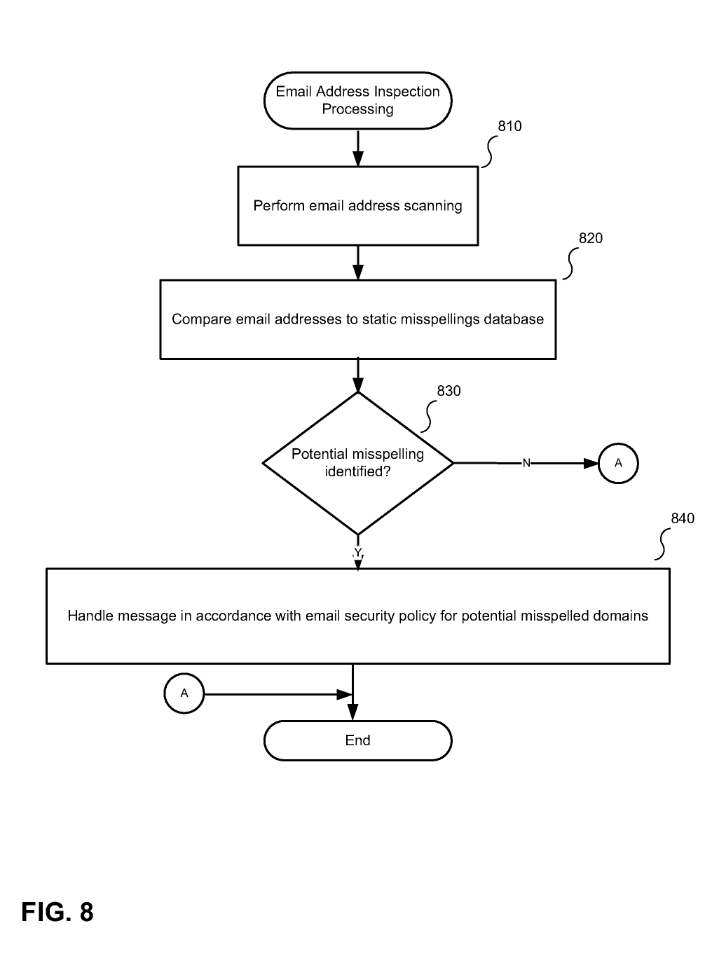

FIG. 8 is a flow diagram illustrating email address inspection processing in accordance with an embodiment of the present invention. Depending upon the particular implementation, the various process and decision blocks described below may be performed by hardware components, embodied in machine-executable instructions, which may be used to cause a general-purpose or special-purpose processor programmed with the instructions to perform the steps, or the steps may be performed by a combination of hardware, software, firmware and/or involvement of human participation/interaction.

At block 810, email address scanning is performed on an email message at issue to determine if it contains or originated from a suspicious email address or domain. For purposes of the present example, the direction of flow of the email message is not pertinent. As indicated above, the email message may be inbound, outbound or an intra-enterprise email message. In various embodiments, however, email address inspection processing may be enabled in one direction only or various detection thresholds could be configured differently for different flows.

At block 820, the email addresses and/or domains identified within the email message at issue are compared to a static misspellings database, such as static misspellings database 223. In one embodiment, a milter, such as milter 221, may be configured with a static misspellings database containing a static list of possible misspellings of one or more target domain names. For example, a company may enable detection just for its own domain name and for the names of its major partners, customers, and suppliers. In other embodiments, email address inspection processing may be enabled for all domains. In other cases, the inspection processing may be enabled only for a selected list of domains. As noted above, in some cases, any friendly names contained in the header of the email message at issue may also be scrutinized in addition to fully specified email addresses.

At decision block 830, it is determined whether any of the email addresses contained within the email message at issue are potential misspellings. In one embodiment, this determination involves matching email addresses contained within the email message at issue to those in the static misspellings database. In alternative embodiments, a proximity algorithm may be employed to determine a degree of similarity between email addresses contained within the email message at issue and those in the static misspellings database to catch potential misspelling variations not accounted for by the misspelling generation algorithm.

According to one embodiment, an exemplary proximity algorithm may perform a case-by-case comparison of an email address at issue against each of the domains in the static misspellings database; however, this may only be feasible if the list of domains is relatively small. To handle a larger list of domains, a more sophisticated algorithm may be employed. For example, the static misspellings database may be pre-filtered by assuming that some subset (e.g., the first and last letters) of the domain name is correct. Likewise, the static misspellings database could also be filtered based on the length of the domain name (e.g., it is unlikely that a 10 character string would be a misspelling of a 20 character domain name).

Additionally or alternatively, in one embodiment, the email address at issue may be run though a processing function to create one or more hash values. The same processing function may be applied to other domain names on this list and then the values may be compared. In one such exemplary function, each letter of the alphabet may be assigned a distinct value and the letters in the domain name may be summed to create a total score. If two strings have the same score, then it is possible that one string is a reordering of the other. In another example, an N character string may be run through a processing function, which produces N different output values, each one corresponding to the above summing function when one character of the input string is deleted. If these output values are compared against a list of hash values generated for each of the target domains, then it is possible to detect all cases where one letter has been deleted or substituted. In one embodiment, the hash value may be represented by an integer value (e.g., an 8-bit, 16-bit or 32-bit value). In other embodiments, the hash value could very well be a larger number or a string. Also, the matching function need not necessarily look for exact matches. For example, the matching function may be implemented to simply check if the difference between the hash values of two strings are within a certain range, or the matching function may examine how many bits are the same in the two hash values.

In one embodiment, if the static misspellings database is reasonably large, then the actual comparison to the email addresses contained within the email message at issue may be performed via a query to an external server. According to various embodiments, this external server has a misspellings database containing a long list of domains, which may be indexed according to one or more hash functions. When the external server receives a query containing an input string (or list of hash values), it may search the database to generate a set of matching (or near matching) domain names. Then, further processing can be performed locally or remotely on this set of generated domain names to determine if the input string is a probable misspelling of any of them.

As indicated above, probable misspellings and/or probable deliberately misleading variations of one or more target domains may be stored in a misspellings database. Potential misspellings and variations included within the list may be generated by various means, such as nearest neighbor algorithms, probable misspellings based on human typing patterns, or other current or future algorithms employed by spell checkers or online dictionaries. At any rate, if an email address contained within the email message at issue matches a misspelling listed in the misspelling database then processing continues with block 840; otherwise the email address inspection processing is deemed complete.

During the course of email address inspection/scanning processing, a milter may choose to flag some domain names/email addresses or some email messages to or from these domains/addresses as “suspicious”. This flagging represents an internal marking system that may be implementation specific. It does not necessarily imply that the actual contents of the email message are changed (although in some embodiments the contents of the email message may be changed). In one embodiment, a variable in memory associated with the email message at issue is changed, one of the headers of the email message at issue may be changed or a warning may be inserted into the subject or body of the email message. Alternatively, this flag may be used by another component of the milter or mail delivery system in order to alter the course of email message processing (e.g., to drop/redirect the email message or to add a disclaimer or warning). If the flag is contained within the email message headers/body, then it may also be interpreted and/or processed by an email client or by another intermediate entity.

At block 840, the email message at issue is handled in accordance with a predefined or configurable email security policy for potential misspelled domains. The email security policy may define any of a variety of actions, including but not limited to, logging an event, dropping the email message at issue, quarantining the email message at issue, tagging the email message at issue as spam, tagging the email message at issue as possible phishing, alerting the email user of the existence of a suspicious email address (e.g., displaying the email address at issue in a different font or color scheme), requesting the sender to reconfirm that the email address at issue is correct (e.g., by popping up a confirmation dialog or asking them to reply to a confirmation email message). Additionally, the action taken may be different for inbound vs. outbound email messages or intra-enterprise email messages.

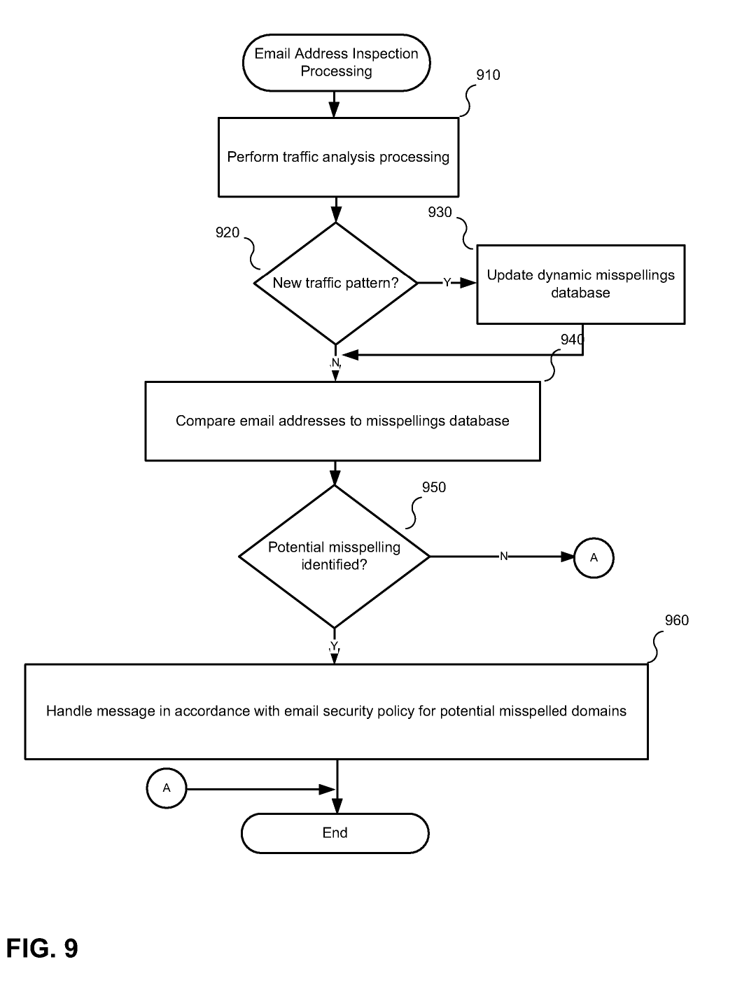

FIG. 9 is a flow diagram illustrating email address inspection processing in accordance with another embodiment of the present invention. At block 910, responsive to an inbound, outbound and/or intra-enterprise email message, traffic analysis processing is performed. According to one embodiment, traffic analysis profiles at one or more levels of intercommunication may be built. For example, normal email traffic patterns among users, servers and/or at a global level may be used to train one or more Bayesian databases of intercommunications between email addresses/domains. In one embodiment, a milter may be provided with a dynamic list of possible misspellings of one or more target domain names. The list may be populated based on traffic analysis. For example, the milter may monitor email traffic to generate a list of observed email addresses and/or domain names.

Spam email messages often use forged domain names or email addresses that do not fit into the same pattern as deliberate misspelled or misleading addresses used by cybersquatters. Therefore, in some embodiments, traffic marked as spam may be excluded from processing when seeding the known misspellings list Likewise, email messages containing viruses could be excluded from processing (although in some cases email messages containing viruses are also sent from legitimate email accounts).

In some embodiments, the number of signatures or entries in the known misspellings list can be pruned by using a name server lookup (nslookup) operation at runtime to check if the domain of the email address is registered or not. This can help to reduce the size of the misspellings database. For outbound email traffic, the nslookup operation can help to distinguish between “innocent” misspellings vs. harmful misspellings that may result in traffic being sent to cybersquatters. For inbound traffic, domains for which the nslookup fails can be added to a watchlist of possible future cybersquatting targets. If one of these domain names is registered in the future, an alert can be generated, and email messages to and/or from these domains can be flagged as suspicious. In some embodiments, the date on which a domain was last registered or transferred may be used as an indicator that that domain is suspicious. Cybersquatters are known to register domain names on short-lived trial contracts or to transfer domain names between multiple holding companies.

At decision block 920, it is determined whether the email message at issue represents a new traffic pattern not observed during an initial training phase. If so, then processing branches to block 930; otherwise processing continues with block 940.

At block 930, if the to and/or from email addresses of the email message at issue do not match the normal pattern of communication, then a variety of further actions may be taken. In one embodiment, if the traffic analysis processing detects an email message between two users who have not previously communicated, then further heuristic analysis may be launched. Depending upon the results of the further heuristic rules (or alternatively without application of further heuristic rules), a dynamic misspellings database may be updated to reflect this new communication pattern and allow for detection of potential misspellings or variations of any newly observed email addresses or domains.

At block 940, the email addresses contained within the email message at issue are compared to the list of observed email addresses and/or a dynamic list of possible misspellings. Either or both lists may be populated based on the traffic analysis. For example, a milter may monitor email traffic to generate a list of observed email addresses and/or domain names. Then, the milter may scan the list to detect if any of the names are probable misspellings of other names on the list.

At decision block 950, it is determined whether any of the email addresses contained within the email message at issue are suspicious, e.g., contained within a known list of misspellings and/or identified as potential misspellings and/or probable deliberately misleading variations of the list of observed email addresses. If so, then processing continues with block 960; otherwise the email address inspection processing is deemed complete.

At block 960, the email message at issue is handled in accordance with a predefined or configurable email security policy for potential misspelled domains. As indicated above, the email security policy may define any of a variety of actions, including but not limited to, logging an event, dropping the email message at issue, quarantining the email message at issue, tagging the email message at issue as spam, tagging the email message at issue as possible phishing, alerting the email user of the existence of a suspicious email address (e.g., displaying the email address at issue in a different font or color scheme), requesting the sender to reconfirm that the email address at issue is correct (e.g., by popping up a confirmation dialog or asking them to reply to a confirmation email message). Additionally, the action taken may be different for inbound vs. outbound email messages or intra-enterprise email messages.

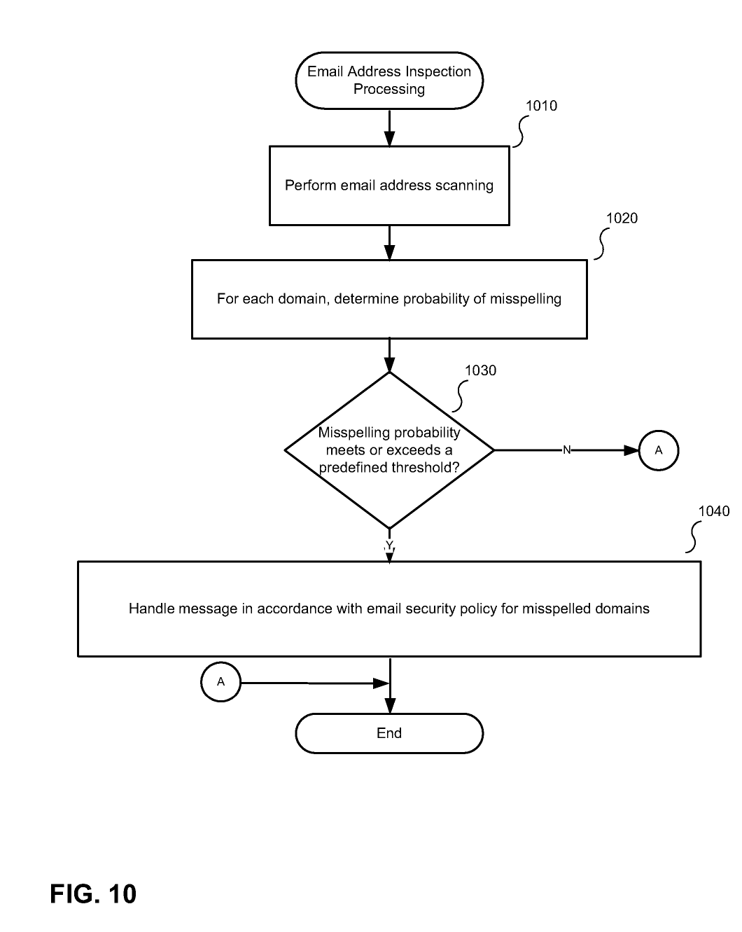

FIG. 10 is a flow diagram illustrating email address inspection processing in accordance with yet another embodiment of the present invention. At block 1010, email address scanning is performed on an email message at issue to identify contained email addresses, such as to/from email addresses.

At block 1020, for each email address and/or domain name identified in the email message at issue, a probability of misspelling is determined. In this example, there may be no list of possible misspellings at all, and a milter may simply calculate the probability of a misspelling at run time with reference to a set of heuristic rules, such as heuristic rules database 426.

At decision block 1030, a determination is made regarding whether a suspiciousness metric, such as a misspelling probability, meets or exceeds a predefined or configurable threshold. If so, then processing continues with block 1040; otherwise email address inspection processing is complete.

At block 1040, the email message at issue is handled in accordance with a predefined or configurable email security policy for potential misspelled domains. As indicated above, the email security policy may define any of a variety of actions, including but not limited to, logging an event, dropping the email message at issue, quarantining the email message at issue, tagging the email message at issue as spam, tagging the email message at issue as possible phishing, alerting the email user of the existence of a suspicious email address (e.g., displaying the email address at issue in a different font or color scheme), requesting the sender to reconfirm that the email address at issue is correct (e.g., by popping up a confirmation dialog or asking them to reply to a confirmation email message). Additionally, the action taken may be different for inbound vs. outbound email messages or intra-enterprise email messages.

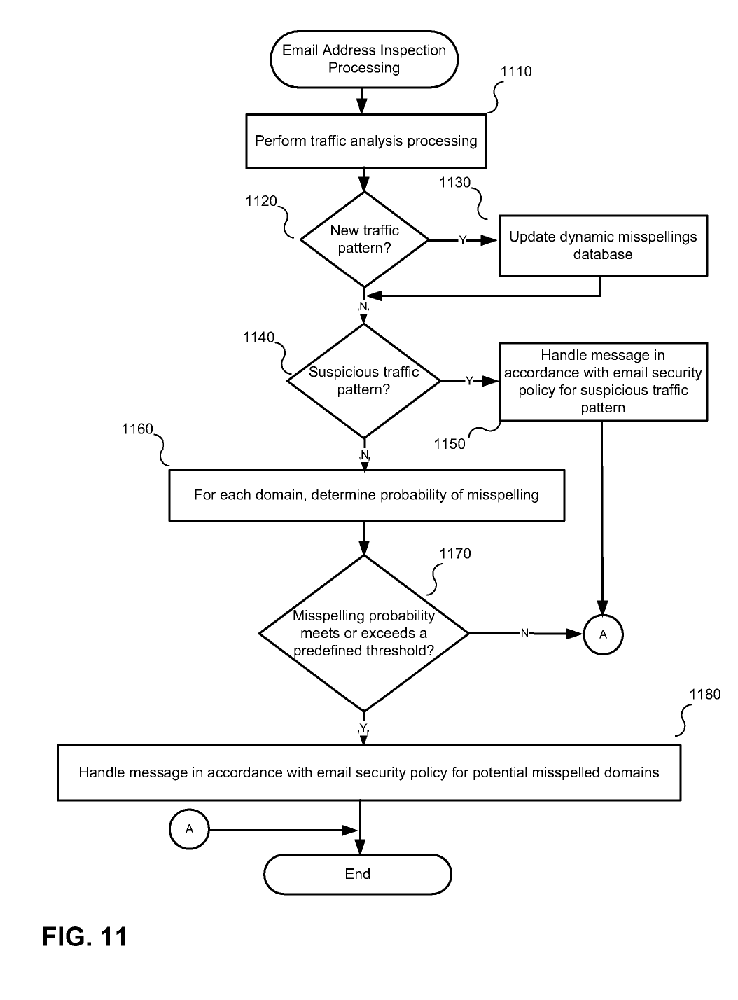

FIG. 11 is a flow diagram illustrating email address inspection processing in accordance with yet another embodiment of the present invention. At block 1110, responsive to an inbound, outbound and/or intra-enterprise email message, traffic analysis processing is performed. As described above with reference to FIG. 9, according to one embodiment, traffic analysis profiles at one or more levels of intercommunication may be built, for example, by training one or more Bayesian databases based on normal email traffic patterns. A misspellings database, such as misspellings database 523 may be built based on the normal traffic patterns. As above, spam email messages and/or email messages containing viruses may be excluded from processing when seeding the known misspellings list.

At decision block 1120, a determination is made regarding whether the email message at issue represents a new traffic pattern not observed during an initial training phase. If so, then processing branches to block 1130; otherwise processing continues with decision block 1140.

At block 1130, if the to and/or from email addresses of the email message at issue do not match the normal pattern of communication, then a variety of further actions may be taken. For example, according to one embodiment, if the traffic analysis processing detects an email message between two users who have not previously communicated, then further heuristic analysis may be launched. Depending upon the results of the further heuristic rules (or alternatively without application of further heuristic rules), a dynamic misspellings database may be updated to reflect this new communication pattern and allow for detection of potential misspellings or variations of any newly observed email addresses or domains.

At decision block 1140, it is determined if the to/from email addresses in the email address at issue represent a suspicious email traffic patterns. For example, the email message at issue is among two or more users who have not previously communicated, the email message at issue includes an email address variant (e.g., *.net or *.org instead of *.com), etc. If it is determined that the email message at issue represents a suspicious traffic pattern, then processing may branch to block 1150; otherwise processing may proceed with block 1160.

At block 1150, the email message at issue is handled in accordance with a predefined or configurable email security policy for suspicious traffic patterns. The email security policy may define any of a variety of actions, including but not limited to, logging an event, dropping the email message at issue, quarantining the email message at issue, tagging the email message at issue as spam, tagging the email message at issue as possible phishing, alerting the email user of the existence of a suspicious email address (e.g., displaying the email address at issue in a different font or color scheme), requesting the sender to reconfirm that the email address at issue is correct (e.g., by popping up a confirmation dialog or asking them to reply to a confirmation email message). Additionally, the action taken may be different for inbound vs. outbound email messages or intra-enterprise email messages.

At block 1160, the email addresses contained within the email message at issue are evaluated by (i) comparing them to the list of observed email addresses and/or a dynamic list of possible misspellings; and/or (ii) determining a probability of misspelling via run-time heuristics and/or in conjunction with a misspellings database.

At decision block 1170, a determination is made regarding whether a misspelling probability meets or exceeds a predefined or configurable threshold. If so, then processing continues with block 1180; otherwise email address inspection processing is complete.

At block 1180, the email message at issue is handled in accordance with a predefined or configurable email security policy for potential misspelled domains. As indicated above, the email security policy may trigger any of a variety of actions, including but not limited to, logging an event, dropping the email message at issue, quarantining the email message at issue, tagging the email message at issue as spam, tagging the email message at issue as possible phishing, alerting the email user of the existence of a suspicious email address (e.g., displaying the email address at issue in a different font or color scheme), requesting the sender to reconfirm that the email address at issue is correct (e.g., by popping up a confirmation dialog or asking them to reply to a confirmation email message). Additionally, the action taken may be different for inbound vs. outbound email messages or intra-enterprise email messages.

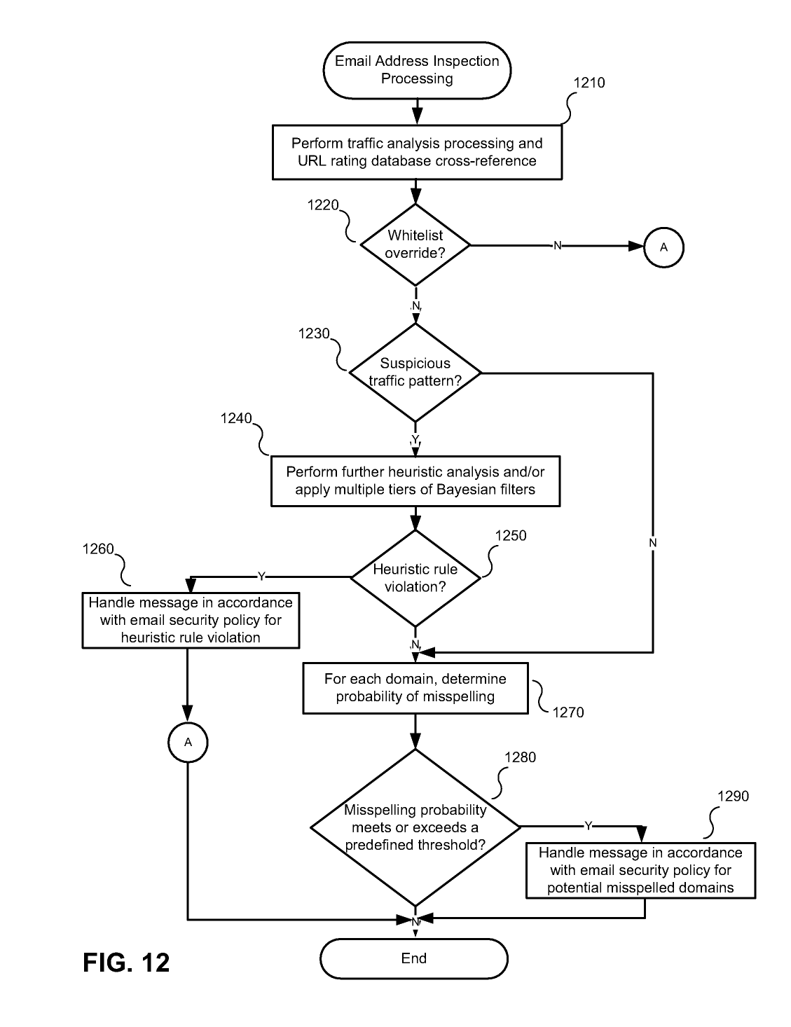

FIG. 12 is a flow diagram illustrating email address inspection processing in accordance with yet another embodiment of the present invention. At block 1210, responsive to an inbound, outbound and/or intra-enterprise email message, traffic analysis processing is performed. As described above with reference to FIG. 9, according to one embodiment, traffic analysis profiles at one or more levels of intercommunication may be built, for example, by training one or more Bayesian databases (such as traffic profile database(s) 626) based on normal email traffic patterns. A misspellings database, such as misspellings database 623 may be built based on the normal traffic patterns and/or selectively supplemented based on newly observed patterns. As above, spam email messages and/or email messages containing viruses may be excluded from processing when seeding the known misspellings list.

According to the present example, a URL rating database or set of URL rating databases may be cross-referenced to assist with the suspiciousness determination. For example, a URL rating service, such as URL rating service 660, may be consulted to determine a legitimacy score and/or usage policy associated with domain names of email addresses in the email message at issue. In one embodiment, domain names associated with a low legitimacy score and/or an unacceptable usage policy may be flagged as suspicious, subject to a list of local overrides. In some cases, the URL rating service may perform category-based rating rather than returning a numerical or Boolean score. In such an embodiment, the category may be translated into a numerical score based on a predefined conversion table. For example, a site categorized as “news” might have a high legitimacy score, whereas one categorized as “spyware” would have a low legitimacy score.

At decision block 1220, it is determined whether there exists an applicable white list override. For example, a white list database, such as white/black list database 622, may be automatically or manually configured with various email addresses and/or domain names that should not contribute to a finding of suspiciousness. In such an embodiment, if all of the email addresses and/or domain names in the email message at issue are contained in the white list, then no further email address inspection processing is required; however, if at least one of the email addresses and/or domain names in the email message at issue are not contained in the white list, then email address inspection processing continues with decision block 1230 (but excluding those of the email addresses in the white list, if any).

Similarly, although not shown, a determination may be made regarding whether there exists an applicable black list override. For example, a black list database, such as white/black list database 622, may be automatically or manually configured with various email addresses and/or domain names that should always result in a finding of suspiciousness. In such an embodiment, if any of the email addresses and/or domain names in the email message at issue are contained in the black list, then no further email address inspection processing is required and the email message should be handled in accordance with an email security policy for a suspicious email address. However, if none of the email addresses and/or domain names in the email message at issue are contained in the black list, then email address inspection processing continues with decision block 1230.

At decision block 1230, a determination is made regarding whether the email message at issue represents a suspicious traffic pattern (e.g., one not observed during an initial training phase and/or the email at issue contains an email address and/or a domain name having a low legitimacy score and/or an unacceptable usage policy). If so, then processing continues with block 1240; otherwise processing branches to block 1270.

At block 1240, responsive to detecting a suspicious traffic pattern, a variety of further actions may be taken. For example, according to one embodiment, further heuristic analysis of the email message at issue may be launched and/or multiple tiers of Bayesian filters, such as traffic profile database(s) 626, may be applied.

At decision block 1250, a determination is made regarding whether the email message at issue violates one or more heuristic rules. If so, processing continues with block 1260; otherwise processing continues with block 1270.

At block 1260, the email message at issue is handled in accordance with a predefined or configurable email security policy for suspicious traffic patterns. The email security policy may define any of a variety of actions, including but not limited to, logging an event, dropping the email message at issue, quarantining the email message at issue, tagging the email message at issue as spam, tagging the email message at issue as possible phishing, alerting the email user of the existence of a suspicious email address (e.g., displaying the email address at issue in a different font or color scheme), requesting the sender to reconfirm that the email address at issue is correct (e.g., by popping up a confirmation dialog or asking them to reply to a confirmation email message). Additionally, the action taken may be different for inbound vs. outbound email messages or intra-enterprise email messages.

At block 1270, the email addresses contained within the email message at issue (excluding the white listed addresses/domains, if any) are evaluated by (i) comparing them to the list of observed email addresses and/or a dynamic list of possible misspellings; and/or (ii) determining a probability of misspelling via run-time heuristics and/or in conjunction with a misspellings database.

At decision block 1280, a determination is made regarding whether a misspelling probability meets or exceeds a predefined or configurable threshold. If so, then processing continues with block 1290; otherwise email address inspection processing is complete.

At block 1290, the email message at issue is handled in accordance with a predefined or configurable email security policy for potential misspelled domains. As indicated above, the email security policy may trigger any of a variety of actions, including but not limited to, logging an event, dropping the email message at issue, quarantining the email message at issue, tagging the email message at issue as spam, tagging the email message at issue as possible phishing, alerting the email user of the existence of a suspicious email address (e.g., displaying the email address at issue in a different font or color scheme), requesting the sender to reconfirm that the email address at issue is correct (e.g., by popping up a confirmation dialog or asking them to reply to a confirmation email message). Additionally, the action taken may be different for inbound vs. outbound email messages or intra-enterprise email messages.

It should be noted, in view of the potentially limitless variations and combinations, the above-described flow diagrams are merely exemplary, and that one of ordinary skill in the art will recognize a variety of alternative and/or additional permutations of the various email address inspection processing flows that may be utilized in relation to different embodiments of the present invention. For example, although URL rating database cross-referencing is only described with reference to the embodiment of FIG. 12, one of ordinary skill in the art will recognize that such cross-referencing may be used in any or all email address inspection processing embodiments to supplement suspiciousness determinations relating to email addresses and/or domains.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A method comprising
receiving an electronic mail (email) message by a mail filter (milter);
evaluating, by the milter, a traffic pattern represented by the email message by scanning information associated with all or a portion of the email message and comparing all or a portion of the scanned information to information associated with one or more traffic analysis profiles;
if the milter identifies the email message as being inconsistent with normal email traffic patterns as represented by the one or more traffic analysis profiles, then the milter causing the email message to be handled in accordance with an email security policy associated with suspicious traffic patterns; and
wherein the milter is implemented in one or more processors and one or more computer-readable storage media of one or more computer systems, the one or more computer-readable storage media having instructions tangibly embodied therein representing the milter that are executable by the one or more processors.

2. The method of claim 1, wherein at least one of the one or more traffic analysis profiles comprises a Bayesian database and the method further comprises training the Bayesian database based on normal email traffic patterns.

3. The method of claim 2, wherein spam email messages and email messages containing viruses are excluded from said training.

4. The method of claim 2, wherein the one or more traffic analysis profiles comprise a multi-tier Bayesian filter.

5. The method of claim 4, wherein the multi-tier Bayesian filter comprises an enterprise-level database, a per-server database and a per-user database and the method further comprises:
monitoring email traffic between email addresses/domains at multiple levels of specificity; and
in connection with making a determination regarding normalcy of a given email traffic pattern, allowing results associated with a more specific database of the multi-tier Bayesian filter to overrule results of a less specific database of the multi-tier Bayesian filter.

6. The method of claim 1, further comprising causing one or more Bayesian filters to be applied to the email message or a portion thereof.

7. The method of claim 6, wherein the one or more Bayesian filters include one or more of a global database based on traffic analysis of observed email traffic, a per-server database based on traffic analysis of observed email traffic for a particular email server and a per-user database based on traffic analysis of observed email for a particular user email account.

8. The method of claim 1, further comprising identifying the email message as being inconsistent with normal email traffic patterns based upon a source email address or a destination email addresses being inconsistent with normal email traffic patterns reflected by the one or more traffic analysis profiles.

9. The method of claim 1, further comprising, the milter concurrently performing one or more of anti-spam processing, anti-phishing processing, anti-virus processing and other email security functions.

10. The method of claim 1, wherein said email message comprises an outbound email message originated by an end user and wherein said causing the email message to be handled in accordance with an email security policy associated with suspicious traffic patterns comprises:
alerting the end user to one or more factors contributing to the identification of the email message as being inconsistent with normal email traffic patterns by causing the outbound email message to be displayed with the one or more factors highlighted; and
allowing the end user an opportunity to address the one or more factors.

11. A program storage device readable by an electronic mail (email) processing computer system, tangibly embodying a program of instructions executable by the email processing computer system to perform method steps for evaluating email messages, said method steps comprising:
receiving an email message;
evaluating a traffic pattern represented by the email message by scanning information associated with all or a portion of the email message and comparing all or a portion of the scanned information to information associated with one or more traffic analysis profiles;
if the email message is identified as being inconsistent with normal email traffic patterns as represented by the one or more traffic analysis profiles, then causing the email message to be handled in accordance with an email security policy associated with suspicious traffic patterns.

12. The program storage device of claim 11, wherein the method further comprises causing one or more Bayesian filters to be applied to the email message or a portion thereof.

13. The program storage device of claim 12, wherein the one or more Bayesian filters include one or more of a global database based on traffic analysis of observed email traffic, a per-server database based on traffic analysis of observed email traffic for a particular email server and a per-user database based on traffic analysis of observed email for a particular user email account.

14. The program storage device of claim 11, wherein the email processing computer system comprises an email firewall.

15. The program storage device of claim 11, wherein the email processing computer system comprises an email security platform.

16. The program storage device of claim 11, wherein the email processing computer system comprises a network security appliance.

17. The program storage device of claim 11, wherein the email processing computer system comprises a gateway.
